(19) United States
(12) Patent Application Publication
(10) Pub. No.: US 2016/0019621 A1
(43) Pub. Date: Jan. 21, 2016

(54) REVIEW BASED NAVIGATION AND PRODUCT DISCOVERY PLATFORM

(71) Applicant: Rare Mile Technologies, Inc., Sunnyvale, CA (US)

(72) Inventors: Amit Jnagal, Sunnyvale, CA (US); Pallav Tandon, Sunnyvale, CA (US); Pratyusha Rasamsetty, Sunnyvale, CA (US)

(21) Appl. No.: 14/639,238

(22) Filed: Mar. 5, 2015

Related U.S. Application Data
(60) Provisional application No. 61/949,884, filed on Mar. 7, 2014.

(51) Int. Cl. G06Q 30/06

(52) U.S. Cl. CPC G06Q 30/0625

(57) ABSTRACT

Methods and systems for providing review based navigation on an ecommerce website are described. The method comprises receiving a user query associated with a specific feature of a product. According to the method, a sentiment analysis of a plurality of reviews associated with the product is performed, along with topic based modeling and contextualization of the reviews by relevance to the query. The analysis may provide a sentiment classification regarding the strengths and weaknesses of each product for that specific feature based on the plurality of reviews associated with the product. The method further provides topic based navigation of the ecommerce website, contextualization of the prior customer reviews, and product relevance. In response to the user query, the contextualized product(s) are displayed to aid the user in selecting a product for purchase.

### TECHNICAL FIELD

The present disclosure relates generally to data processing and more particularly, to text analytics and text mining engines for providing review based navigation.

### BACKGROUND

Some existing eCommerce marketplaces provide product information from multiple merchants, enabling a user to compare, choose, and buy products online. For example, a customer can be browsing an eCommerce marketplace looking for a comfortable pair of sneakers that would be perfect for recovery from a recent knee surgery. The customer can start browsing in a way most customers would, by using keywords and going down the site hierarchy. After spending some time looking at sneakers, the customer would be able to filter down to a few choices. However, the customer may still be looking at a great number of choices. The customer can try sorting the candidate sneakers by relevance and read what other customers are saying about the ‘comfort’ level of the shoes but the top products sorted by relevance can have hundreds or even thousands of reviews. At this point, the customer can give up the idea of the online purchase and decide to check out a local store so he can try the shoes on.

Thus, existing eCommerce marketplaces do not provide an efficient way of allowing customers to quickly find a specific feature related to a product, e.g. whether shoes are comfortable for people with recent surgeries.

### BRIEF DESCRIPTION OF DRAWINGS

FIG. 1 is a schematic drawing illustrating various types of shopper on eCommerce sites;

FIG. 2 is a schematic drawing illustrating product discovery evolution for the last two decades;

FIGS. 3-7 are schematic drawings illustrating the strengths and weakness of approaches used for product discovery;

FIG. 8 is a schematic drawing illustrating the problems associated with using review and opinions as a driven mechanism of product discovery;

FIG. 9 is a schematic drawing showing the main principles and benefits of a review based navigation and product discovery system, which is constructed in accordance with the present invention;

FIG. 10 is a schematic drawing illustrating how the review based navigation and product discovery system of the present invention operates;

FIG. 11 is a schematic drawing illustration typical questions that the review based navigation and product discovery system of the present invention answers in response to end user queries;

FIG. 12 is a schematic drawing illustrating an exemplary product review as seen by an on-line shopper interacting with the review based navigation and product discovery system of the present invention;

FIGS. 13-16 are schematic drawings illustrating exemplary contextualized product reviews as generated by the review based navigation and product discovery system of the present invention;

FIGS. 17-22 are schematic drawings illustrating examples of how the review based navigation and product discovery system of the present invention may aid an on-line shopper in the discovery of a product with specific traits;

FIG. 23 is a schematic drawing of an analytic chart generated by the review based navigation and product discovery system of the present invention;

FIG. 24 is a schematic drawing of another analytic chart generated by the review based navigation and product discovery system of the present invention;

FIG. 25 is a schematic drawing illustrating exemplary product traits times with the number of occurrences of navigation for positive traits and the number of occurrences of the top negative traits in on-line reviews;

FIG. 26 is a schematic drawing illustrating a change of a number of occurrences of navigation for positive traits and negative traits of a specific period;

FIG. 27 is a schematic drawing illustrating the number of positive and negative comments that may be shown for a given product;

FIG. 28 is a schematic drawing illustrating a display of the latest customer sentiments providing the most recent positive reviews and the most recent negative reviews; and

FIG. 29 is a schematic drawing of an exemplary computing system for implementing the review based navigation and product discovery system and methods of the present invention.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense.

The present disclosure relates to methods and systems for generating website navigation from user review comments. In addition to providing an effective way of finding products that match needs of a customer, the methods and systems of the present disclosure also provide navigation that is based on a viewpoint of the customer and not on a viewpoint of merchandisers. More specifically, an example system can seamlessly integrate with an eCommerce website, extract reviews and create a navigation based on a perspective of the customer rather than a view of product hierarchy of a merchant.

Every customer review can offer valuable insights about the product such as strengths, weaknesses, value as a gift, fitness for a particular purpose, and various other attributes. The present disclosure is an eCommerce solution which allows creating and presenting a navigational structure based on the product attributes extracted from the customer reviews. An example system can use advanced text analytics techniques and extract product attributes which can be easily missed by the product marketers and manufacturers.

In one example embodiment, an advanced algorithm can analyze reviews and create hierarchy of product features that makes browsing thousands of customer reviews simple. The system can analyze these reviews to extract contextual insights so that the customers can find what is relevant to them. Therefore, the system can assist in and speed up the buying process. The system also effectively allows for past customers to sell products to new customers.

Customers, on average, may read two or three comments for a product. But user comments contain a wealth of information that can help customers make decisions regarding the product purchase. Usually this information is lost because of the amount of reviewing it takes to get to it. The system of the present disclosure pulls up this information and structures it into an intuitive product navigation to make right product selections an easy task.

The reviews based navigation approach creates a model for discovering products based on what other customers think as opposed to the merchandizer opinion. This approach is similar to using the customers to market products to other customers. The system reduces abandoned carts by providing trustworthy insights to the customers who are undecided and unwilling to search through hundreds of reviews.

Besides providing a powerful navigation system on the market, the system uses sentiment analysis engine to alert customers about negative reviews. Manufacturers can use this information to reach out to the customers who have had a had experience and marketing professionals can use it to track customer's feedback and perception of their products over time.

The system can help customers who are held back from adding a product to cart because they are not sure, The system can find answers to questions like ‘Will this shoe have enough ventilation for my sweaty toes?’, ‘Is there a better TV that has better sound?’, and ‘What's the most relaxing perfume on this website?’ from user reviews and help customers make a decision about the product purchase. In particular, the system uses advanced text analysis techniques to derive hidden intelligence and insights from the reviews in order to make product discovery and selection simple, thus eliminating the need for reading thousands of reviews. Furthermore, the system may aid a customer in finding a product suitable for a particular purpose, in a category that the merchant may not have even considered. For example, the customer may be looking for a coat suitable for a pregnant woman or shoes for diabetics.

An example system includes a text analytics and text mining engine. The engine can review large documents and texts and extract intelligence. Moreover, the engine can integrate with user ratings and user reviews of products on e-commerce websites. The customer of the engine can see only a user interface with nothing being installed on the machine on the customer end.

The method for generating website navigation from user review comments can comprise a sentiment analysis. The sentiment analysis can include predicting or suggesting a specific product to a customer based on the sentiment of user reviews. Furthermore, the method can allow navigation of an e-commerce site. In particular, a customer can be enabled to navigate an ecommerce site to find a particular product. For example, if the customer is looking for a shoe with a good arch support, the customer can filter/navigate the website to only those products that are associated with user reviews concerning arch support. Once filtered, the customer can read the relevant reviews to see what users are saying about the arch support for various shoes to help the customer in selecting a product to buy.

By reading the reviews, the customer can determine strength/weaknesses of the product. Furthermore, the system can highlight the relevant parts of the user reviews, so the customer can immediately see the relevant portions instead of having to read the entire user reviews.

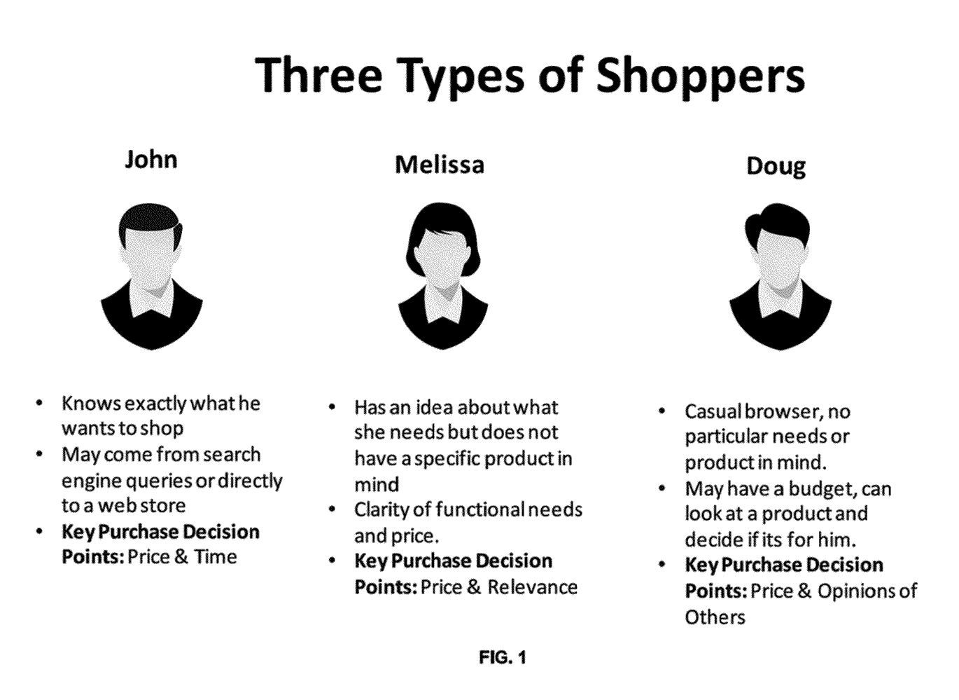

FIG. 1 illustrates various types of shoppers on e-commerce sites. Customer 1, e.g. John, represents people who know exactly what product they want to buy and are looking for the right vendor to buy it from Customer 2, e.g. Melissa, represents people who know what type of product is needed hut do not have a specific model in mind. For example, customer 2 wants shoes with good arch support or wants a laptop that is not too heavy so it can be used for travel. This type of customer is a target shopper for the system of the present disclosure. Customer 3, e.g. Doug, has no particular needs or product in mind; he may be simply ‘window shopping’ online and can look at a product and decide whether to buy the product.

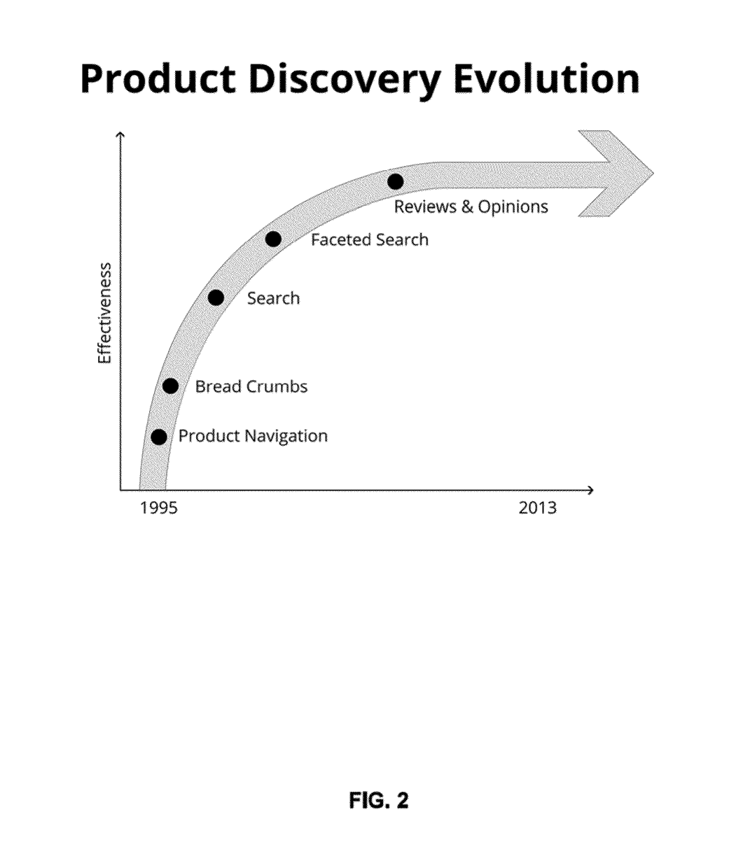

FIG. 2 illustrates product discovery evolution for the last two decades. As shown, product discovery can be affected by product navigation, breadcrumbs, search, faceted search, and reviews and opinions. As FIG. 2 shows, currently effectiveness of product discovery is influenced most by reviews and opinions related to products. In other words, potential customers pay attention to reviews and opinions when searching and selecting the product.

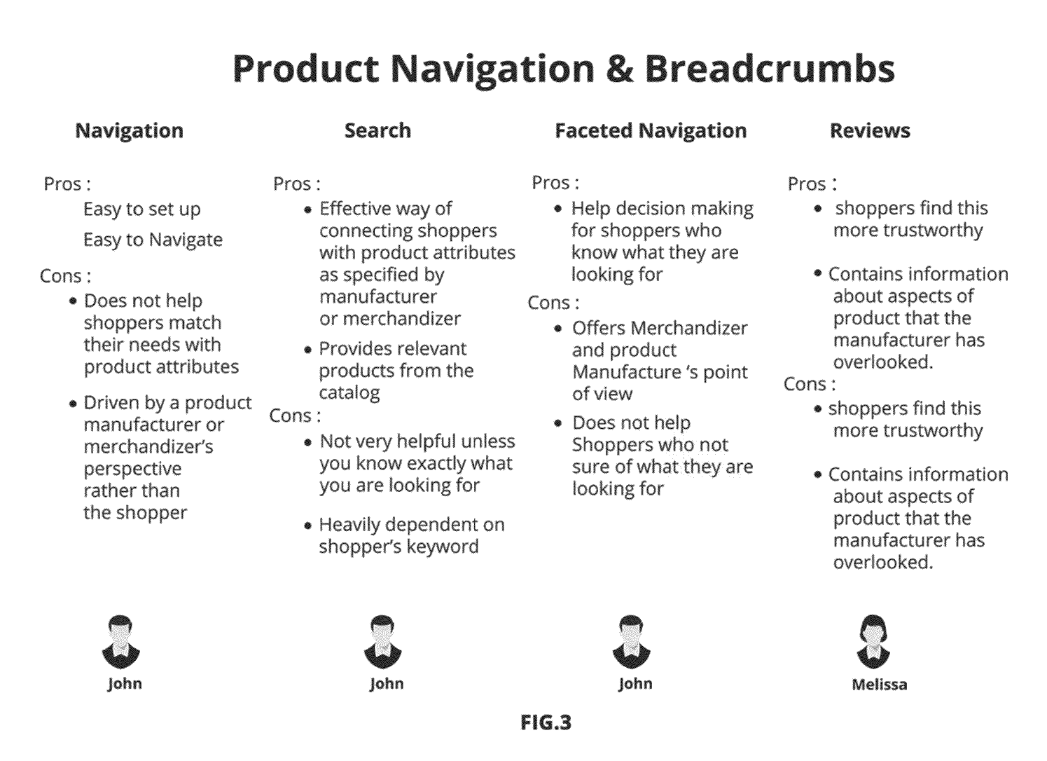

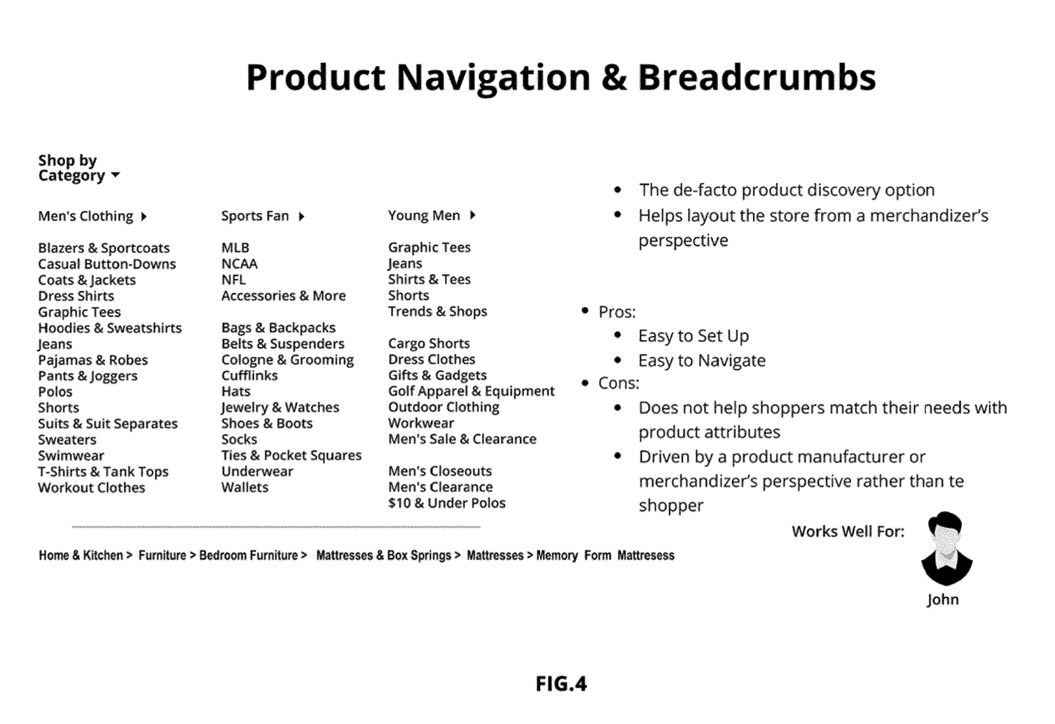

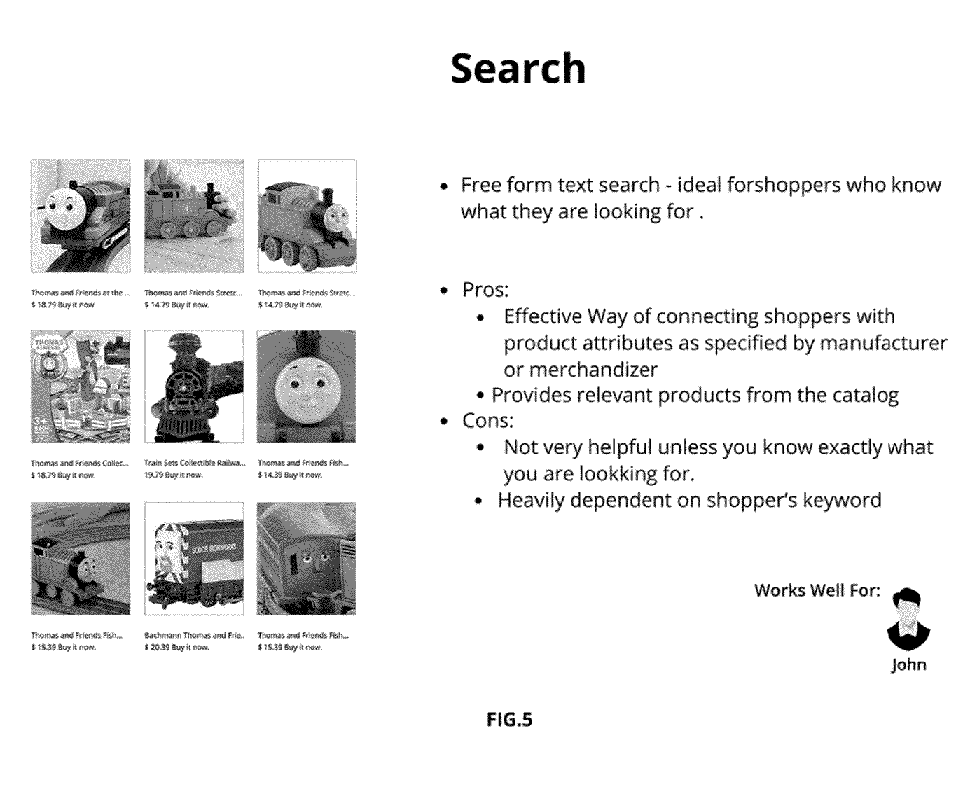

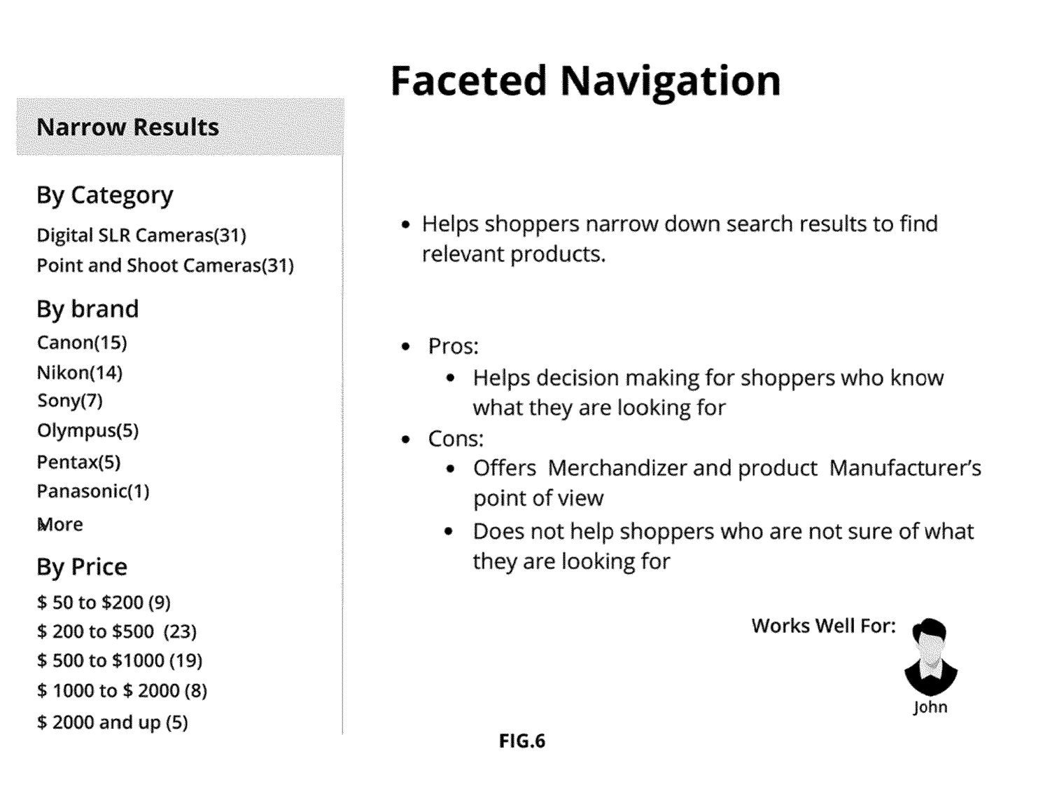

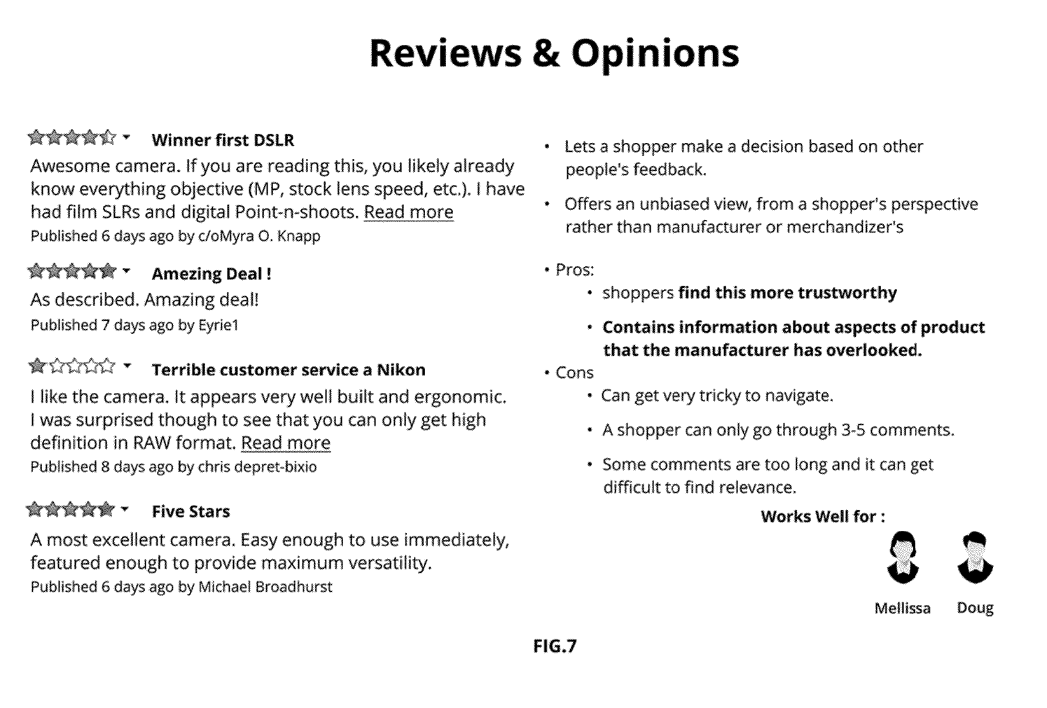

FIGS. 3-8 show strengths and weaknesses of the approaches used for product discovery. Whereas navigation provides easy set up and navigation, it does not help shoppers match their needs with product attributes. Current e-commerce websites have product navigation that is basically a category (e.g., Amazon has categories for books, kindle, electronics, and furniture). A department store's website may have categories for home, bed and bath, women's clothing, men's clothing, kids, etc. However, the navigation is driven by a product manufacturer or merchandiser perspective rather than the shopper. Furthermore, the categories are not useful for navigating the site for a particular feature/attribute (e.g., shoes with arch support).

A search feature on an e-commerce website is usually a free form text search

that may be ideal for shopper who know what they are looking for. It can provide an effective way of connecting shoppers with product attributes as specified by a manufacturer or merchandiser, as well as to provide relevant products of the catalog. Some websites allow a customer to search for a specific item, but the search is not very effective is not very helpful unless the shopper knows exactly what he or she is looking for. Furthermore, the effectiveness of the search results is heavily dependent on the keywords of the shopper.

Faceted navigation helps shoppers narrow down search results to find relevant products, it may help decision making for shoppers who know what they are looking for. However, faceted navigation represents items from the point of view of the manufacturer and merchandiser, and does not help shoppers who are unsure of what they are looking for.

Reviews and opinions of other (prior) shoppers let a shopper make a decision based on others' feedback, it offers an unbiased view, from a shopper's perspective, as opposed to from a manufacturer or merchant's perspective. Also, shoppers generally find reviews and opinions more trustworthy, as reviews and opinions may contain information about aspects of the product that the manufacturer and merchandiser have overlooked. However, this type of product discovery can get very tricky to navigate, as there may be conflicting opinions by different shoppers. Furthermore, the shopper may review only 3-5 comments. Some comments are too long and it may be difficult to find relevance if the shopper is looking for information about a specific product feature or attribute.

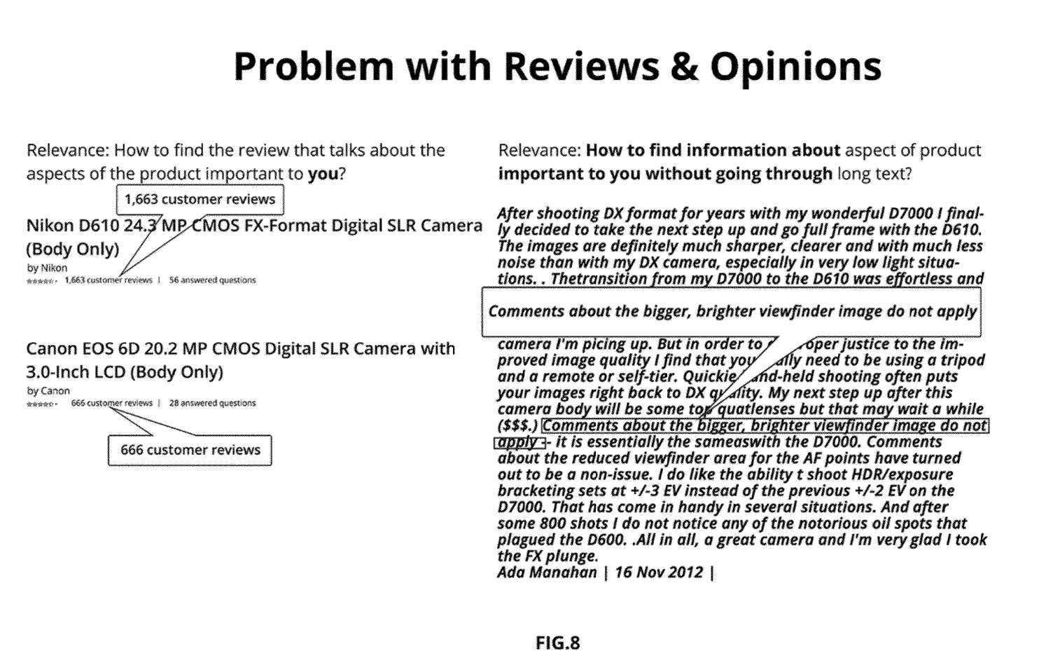

FIG. 8 shows problems associated with using reviews and opinions as a driven mechanism for product discovery. More specifically, as a number of reviews may be great, e.g. thousands or even more, an efficient way to find a review that relates to aspects of the product important for the customer should be provided. Furthermore, it is important to find the way of getting information concerning aspects of the product important to the customer without going through all of the reviews.

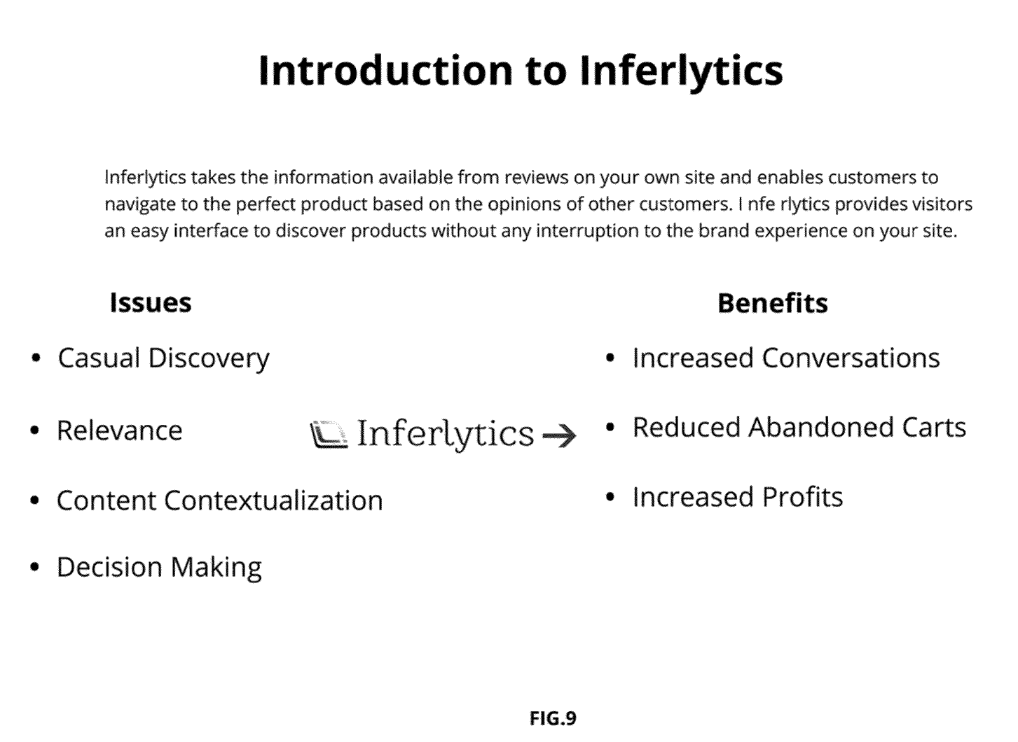

FIG. 9 shows main principles and benefits of the system. The system is directed to such issues as casual discovery, relevance, context visualization, and decision making. The system takes the information available from reviews on a site and enables customers to navigate to the suitable product based on the opinions of other customers. The system provides visitors with an easy interface to discover products without any interruption to the brand experience on the site. Benefits provided by the system include increased conversions, reduced abandoned carts, increased profits, and so forth.

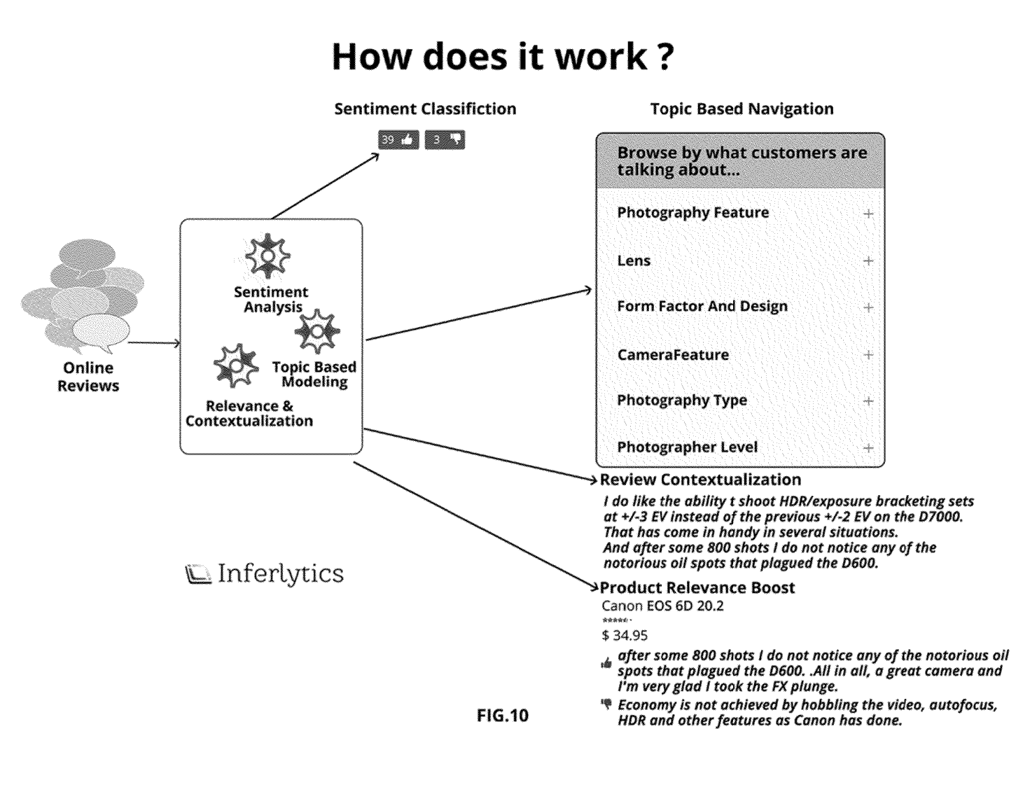

FIG. 10 provides a schematic illustration of how the system works. The

software engine of the system goes through all reviews on an e-commerce site and conducts a sentiment analysis of each of the reviews, topic based modeling, and organizes the reviews based on relevance and context. From this analysis, the system can create sentiment classification whereby it can show the number of positive reviews and the number of negative reviews. The system can also create categories/navigation based on what users have discussed in the reviews. In particular, the engine creates a custom navigation structure based on the text of the reviews, e.g. laptops for travel, shoes with an arch support, amplifiers for playing musk in a church, and so forth. From this it creates various navigation categories and allows the shopper to navigate the ecommerce website by topic. Furthermore, the system can highlight the particular portion of an online review that discusses the topic, thereby allowing the shopper to immediately jump to the relevant portion of each online review, instead of having to read all reviews. In addition, the system may show the product relevance. In an exemplary embodiment depicted in FIG. 10, the system shows the online reviews for a particular pair of shoes and the breakdown of the number of people that have rated that shoe in a positive manner or in a negative manner for specific topics (comfort, running, feet, support, ankle, etc). The specific topics may be generated from the text of the reviews themselves, rather than by some predetermined categorization set by the merchant.

The creation of the navigation structure is a key element of the system. The

system generates website navigation by analyzing the product reviews and categorizing different traits of products that customers have discussed. This intuitive navigation model lets customers discover products from a perspective that search engines and merchandizes currently ignore.

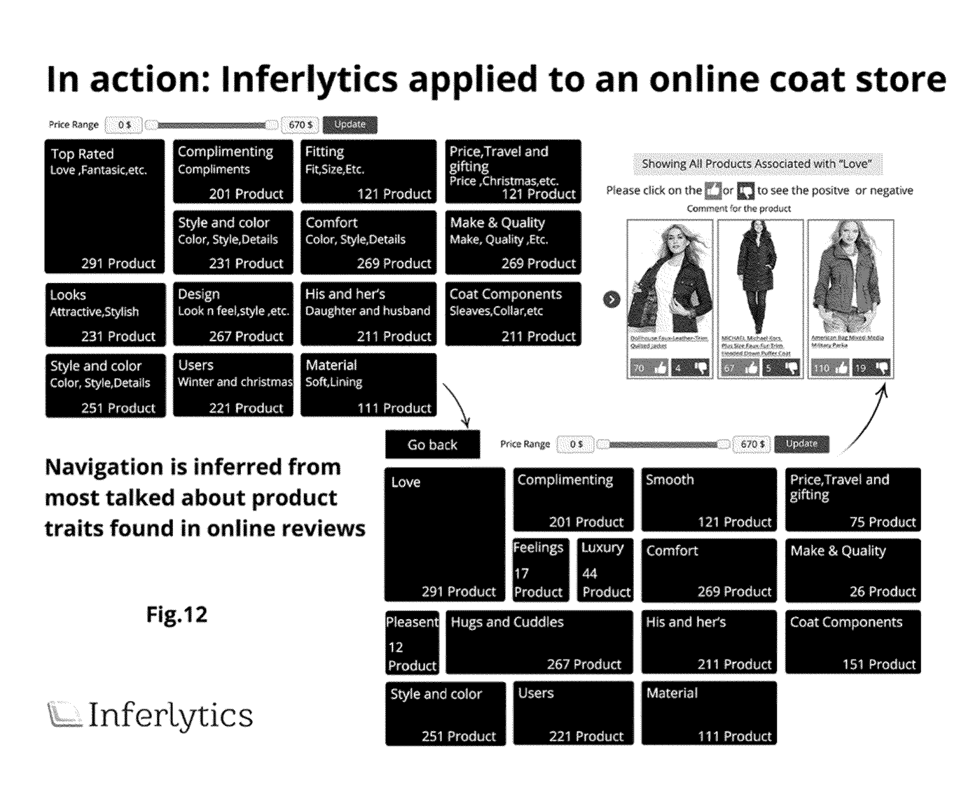

FIG. 12 provides an exemplary product view as seen by the customer of an online coat store. The navigation structure shows various traits that are discussed in the online reviews for all of the coats on that website. In an exemplary embodiment, the shopper may select the “feelings” button and be taken to a sub-navigation menu whereby the various feelings discussed in the online reviews are shown. By selecting “love”, the shopper is then shown only those coats in which previous users have used the word “love” in their online review. The products are presented to the customers with a product trait along with an analysis of positive and negative review comments. This lets the customer see, for a given product trait like “love”, how many customers are leaving positive feedback vs. how many customers are leaving negative feedback using the word “love” in their review.

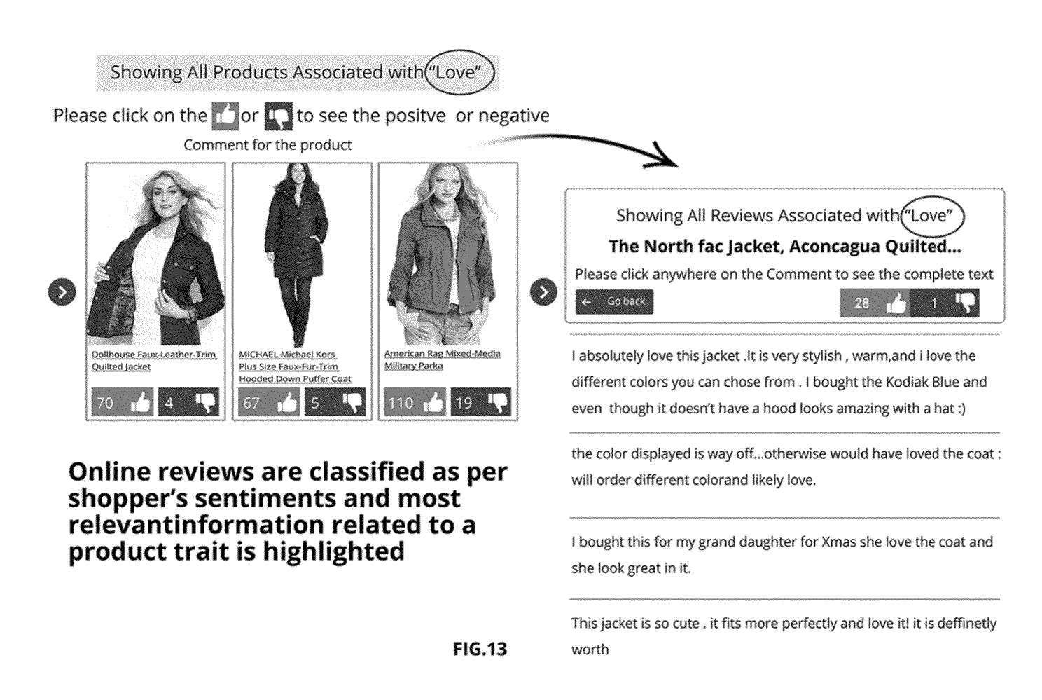

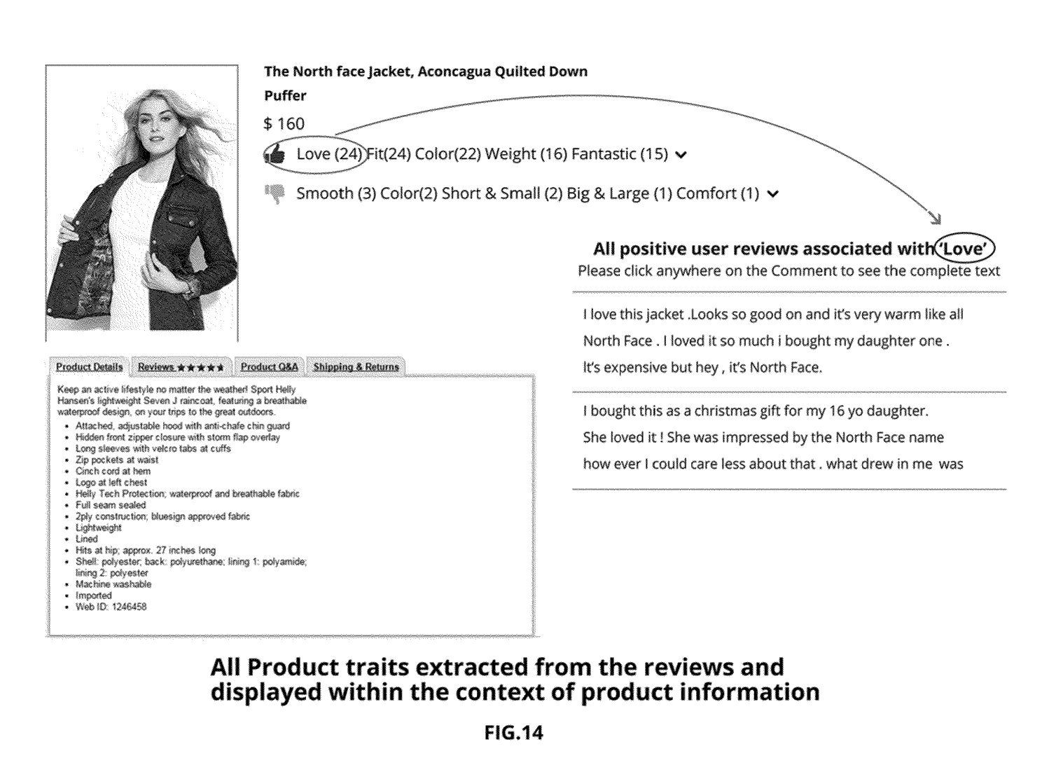

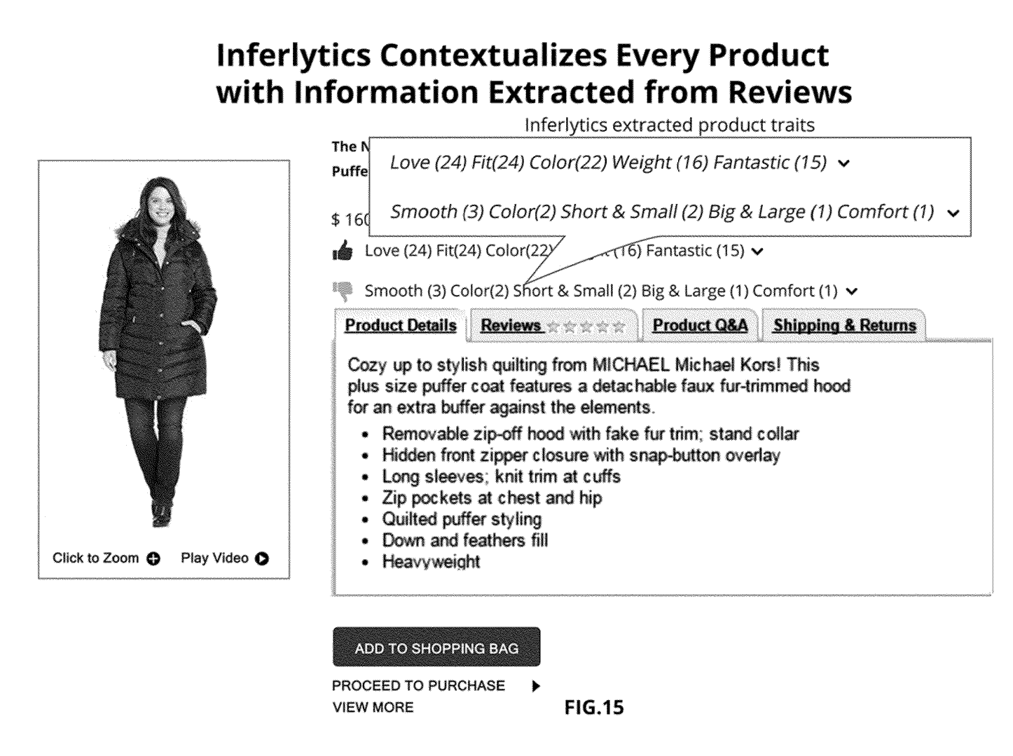

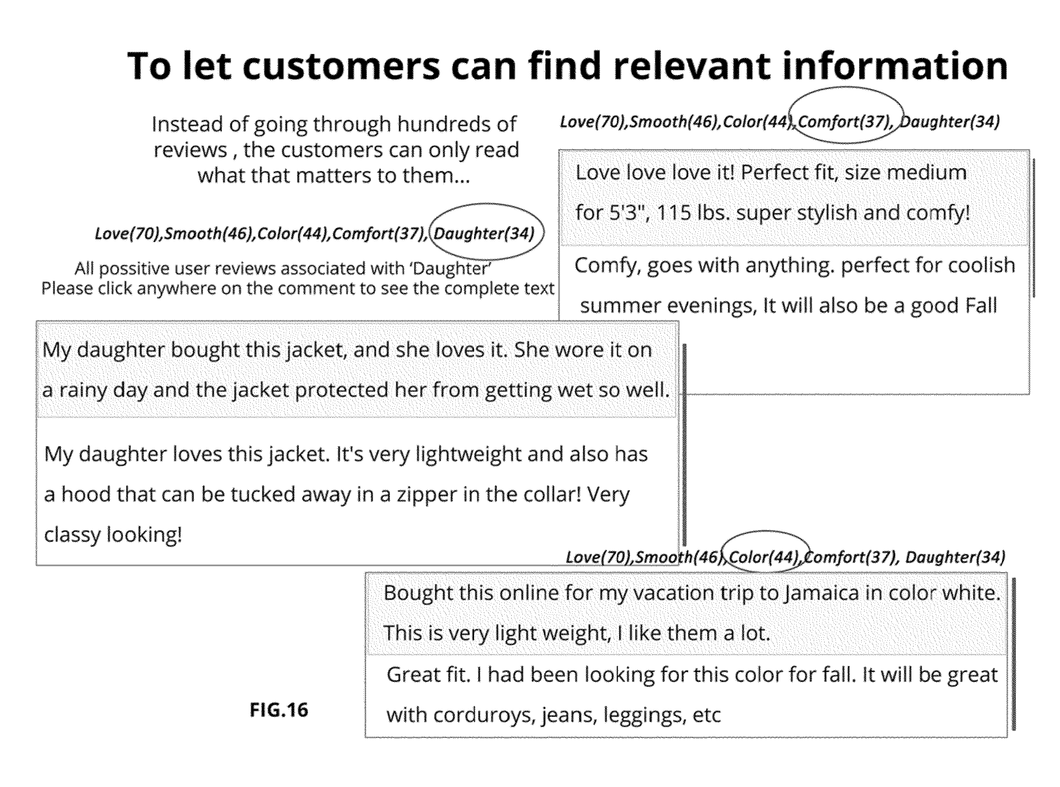

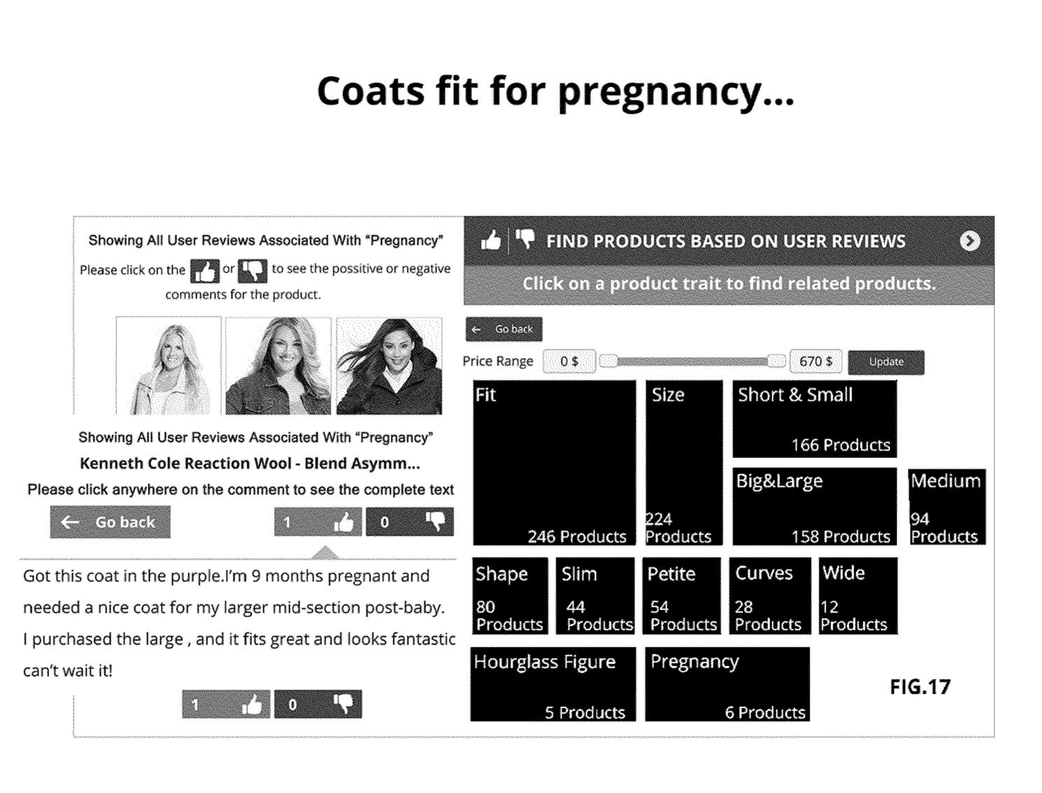

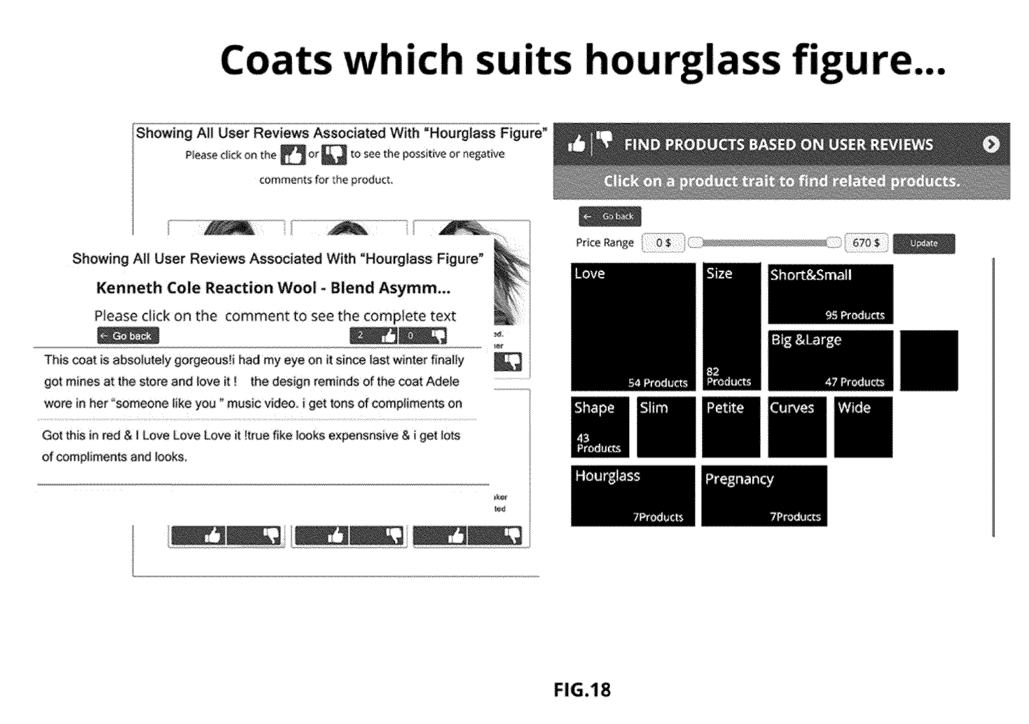

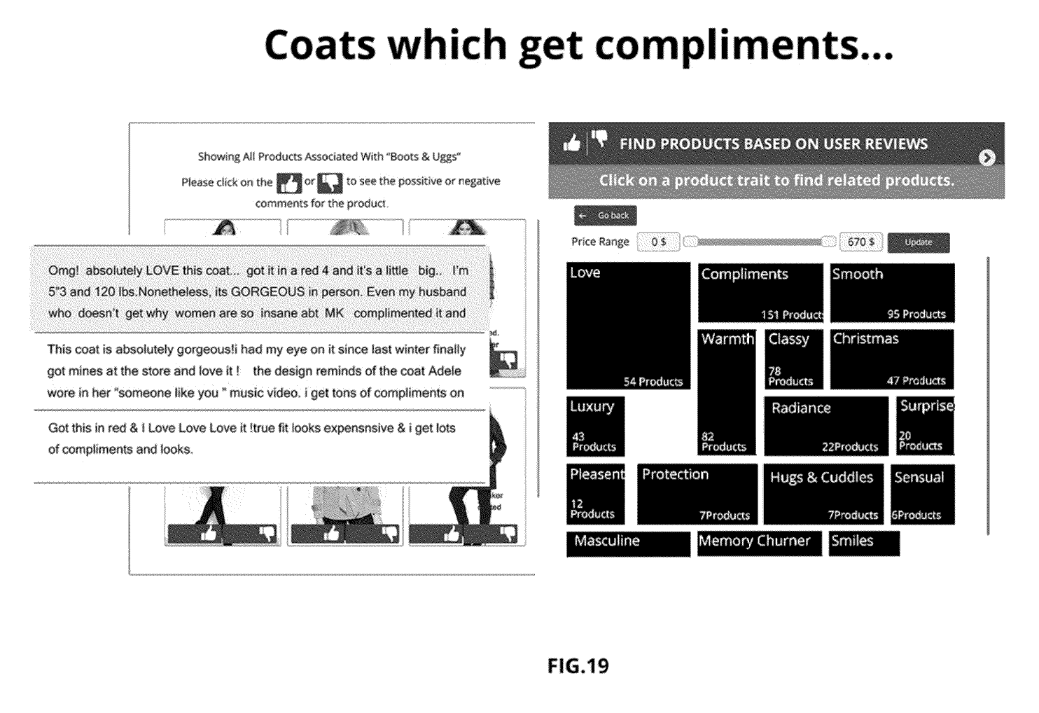

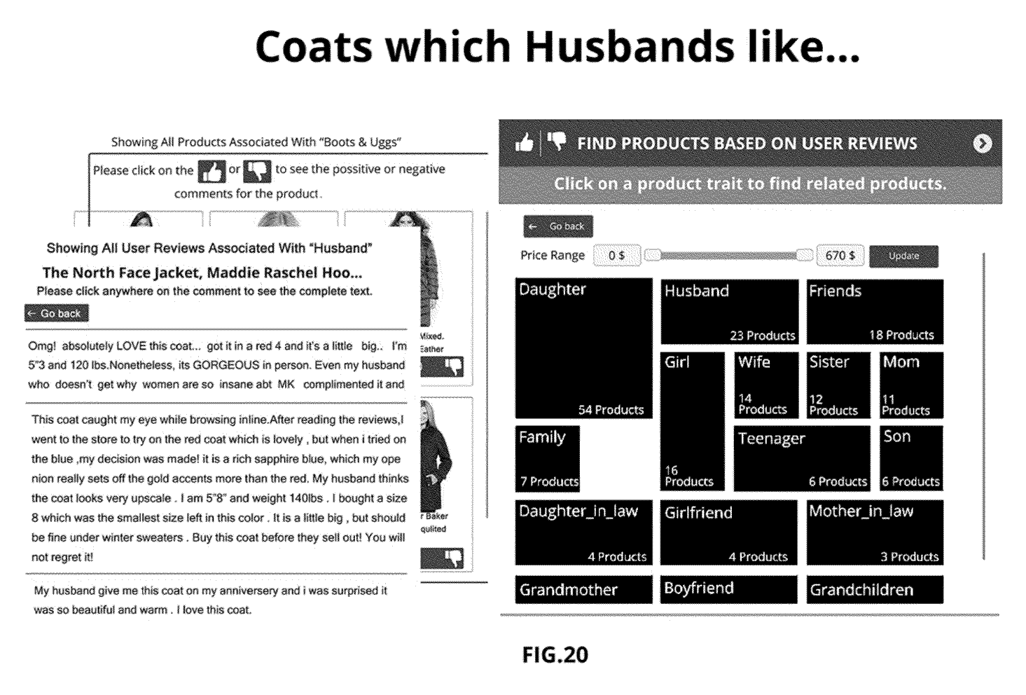

FIGS. 13-16 show exemplary contextualized product reviews. The system contextualizes product reviews so that the customers only see the part of the review that is relevant to the topic category. Thus, instead of weeding through long review comments to figure out where relevant information is, the customers can quickly go through the highlighted information. The customers can then see the products that are relevant to the category of interest, and view the relevant (highlighted) part of the reviews that are positive and the relevant part of the reviews that are negative about that specific trait. This helps eliminating any ambiguity about the products. As shown on FIG. 13, the system contextualizes every product with information extracted from reviews. The contextualized information is included into the product details, in the exemplary embodiment depicted in FIG. 13, the shopper has chosen the category “love” and the system is displaying highlighted portions of user reviews where people have used the word “love”, thereby enabling the shopper to quickly see what others are saying about that topic as related to the particular coat.

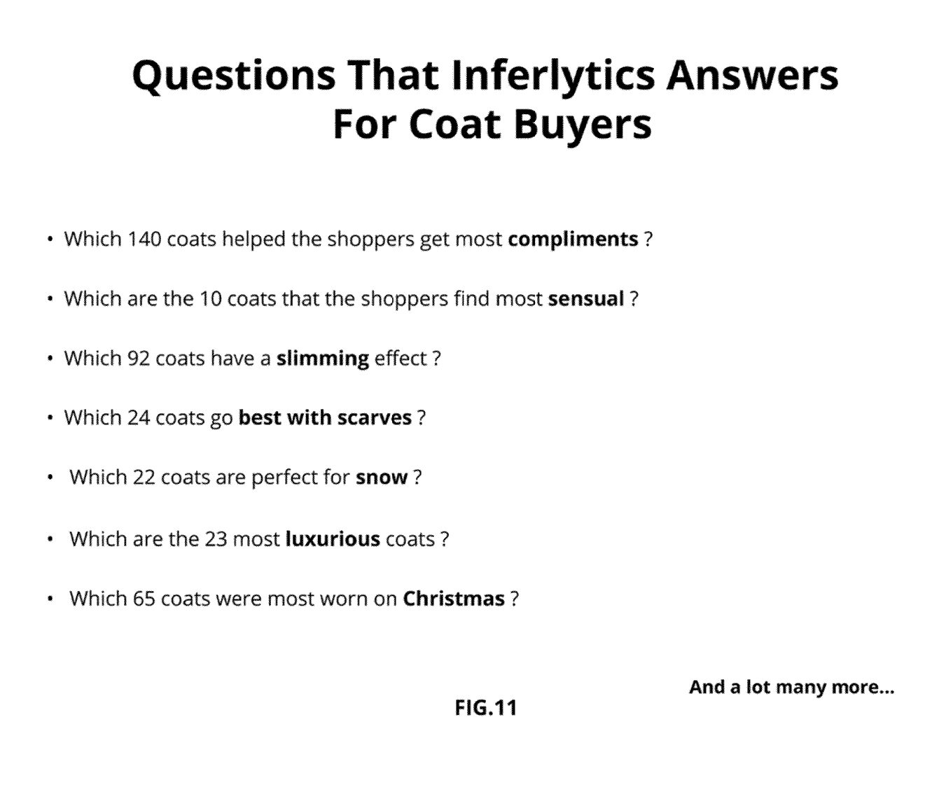

A search of product details can be an important instrument for product discovery on existing eCommerce sites. However, search in product details is not always effective on existing ecommerce sites, as irrelevant products often appear in searches. Furthermore, a specific attribute that the customer is looking for can be absent from the product details. The customer can look for specific attributes that the manufacturer or the merchant usually do not specify in product details, for example, “coats that get you compliments”, “coats that husbands like”, “coats that go well with boots”. “coats worth the money”, and the like. On the contrary, as shown on FIG. 1722, the present system may aid the shopper such that search in product reviews is effective, as the product reviews comprise much more information than that simply provided in the product details by the merchant. The specific traits not specified by the manufacturer or the merchant can be found in the product reviews provided by the customers who have already bought the product. For example, product reviews can answer such specific questions as “Which 140 coats helped the shoppers get most compliments?”, “Which are the 10 coats that the shoppers find most sensual?”, “Which 92 coats have a slimming effect?”, “Which 24 coats go best with scarves?”, “Which 22 coats are perfect for snow?”, “Which are the 23 most luxurious coats?”, “Which 65 coats were most worn on Christmas?” and the like, as shown on FIG. 11.

In an example embodiment, the software engine of the system is set up as a widget on the side of the website, which may be expanded into a navigation panel on the side. The panel can be quickly accessed by the customer. The product categories in the navigation panel may be updated periodically to provide the most up-to-date sentiment analysis of the product reviews. In an exemplary embodiment, the navigation panel may be updated daily.

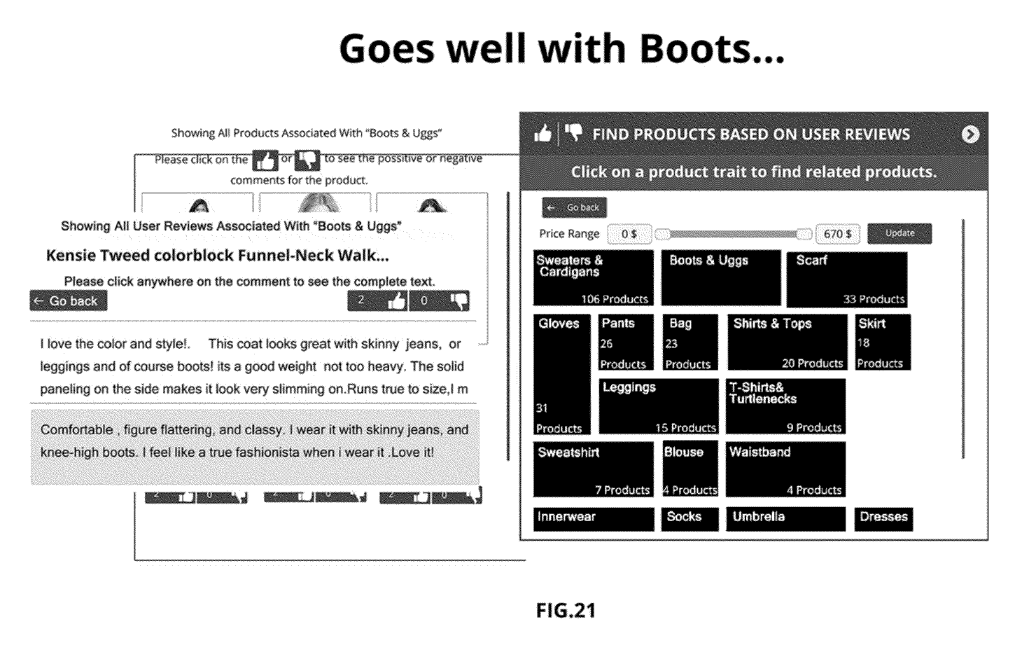

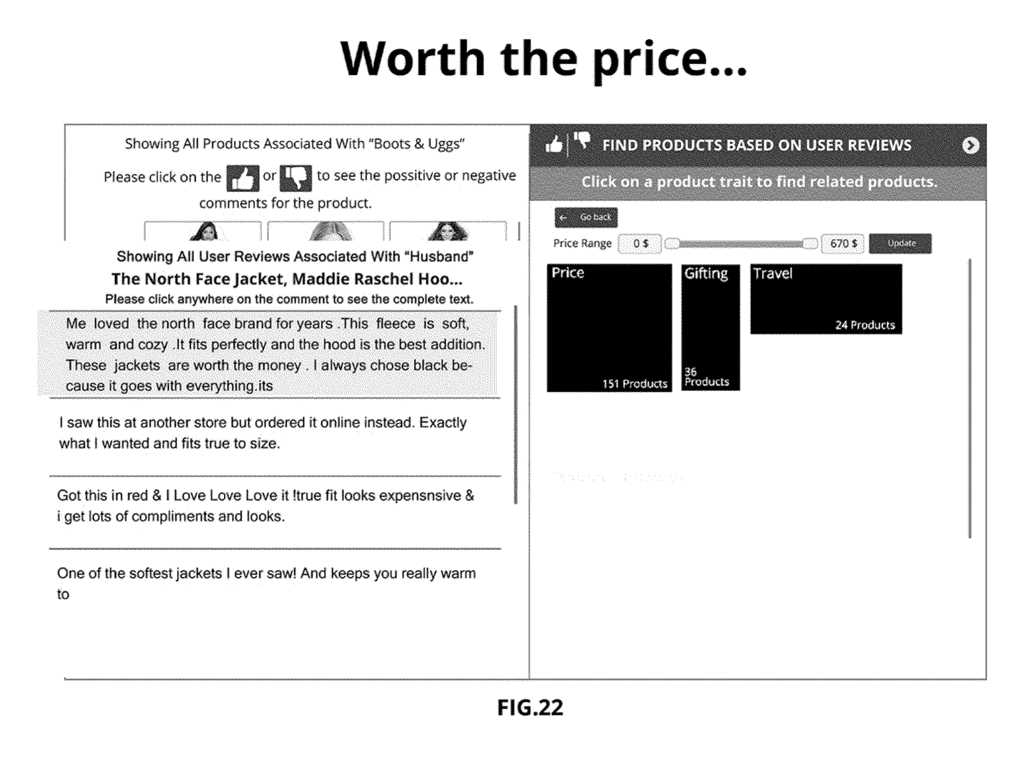

Moreover, product categories can help e-commerce sites with crossseliing. For example, previous customer reviews for a particular coat may discuss how the coat goes with a particular boot or scarf. This information can be shown to the customer. In the exemplary embodiment depicted in FIG. 21, the customer may choose “boots & uggs” from the navigation panel The system may then display to the user all of the coats available where user reviews have mentioned boots or uggs, along with the number of positive reviews about the coat with boots or uggs and the number of negative reviews. From there, the customer may navigate to a particular product and choose to read the relevant portions of the positive reviews, and/or the relevant portions of the negative reviews.

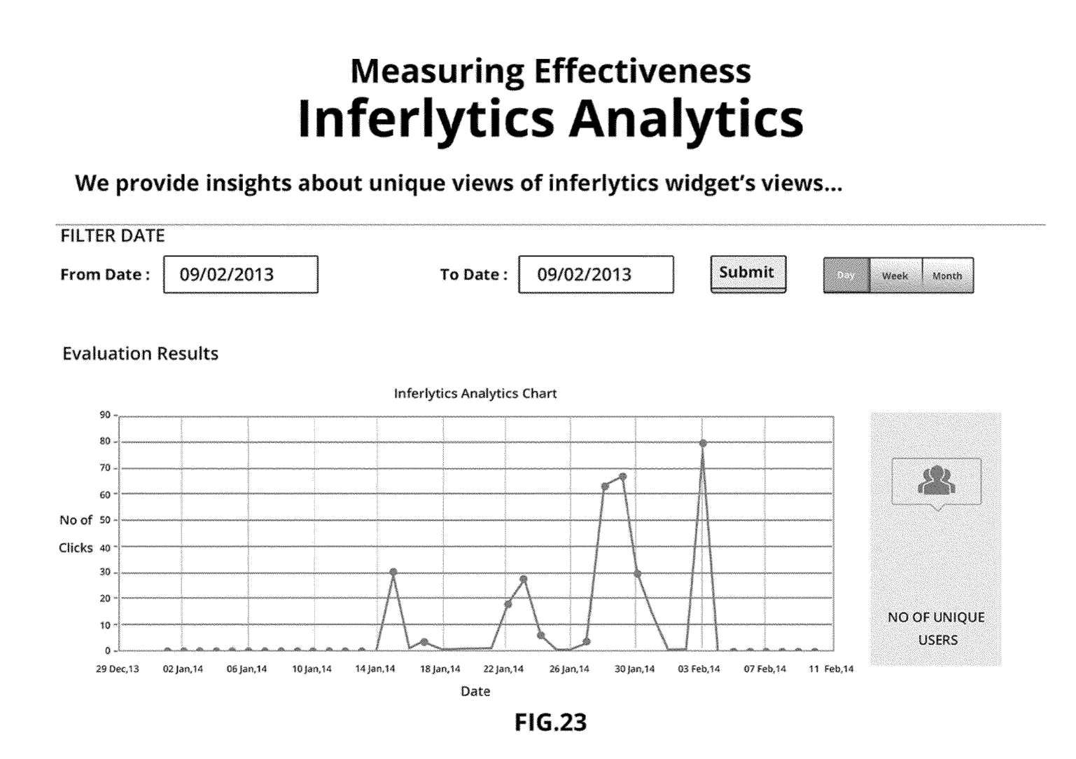

In an example embodiment, the system comprises an analytics module responsible for evaluation of customer behavior. FIG. 23 shows an analytics chart provided by the analytics module. The analytics chart may show various statistics, such as an evaluation of the number of clicks on reviews by time, number of unique users, and so forth. Specific date can be selected for analysis.

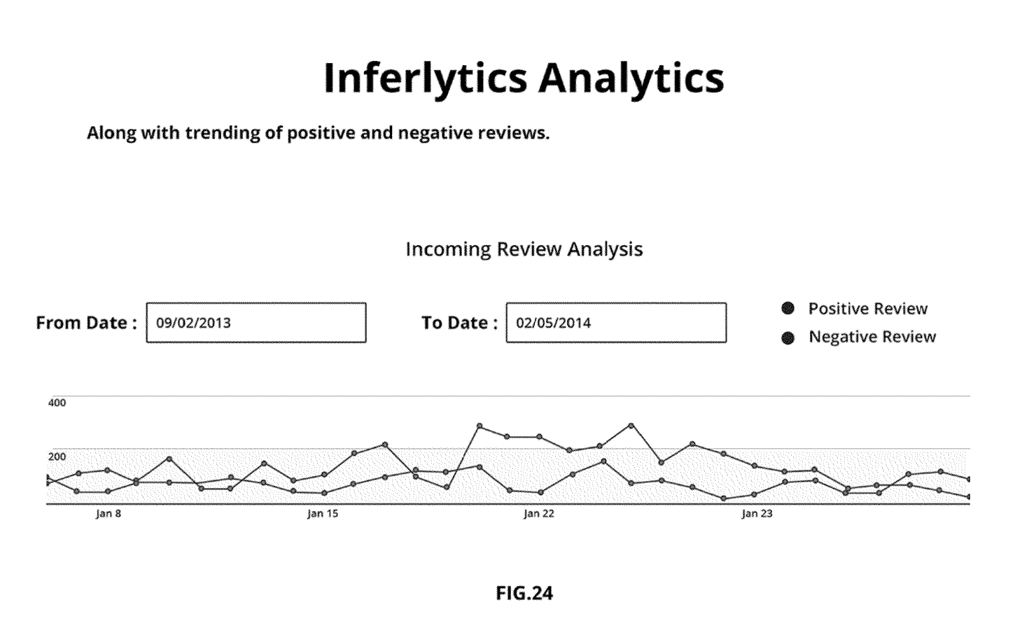

The analytics module can also analyze trending of positive and negative reviews, FIG. 24 is an analytics chart showing incoming review analysis by time. Number of clicks is shown for positive and negative reviews.

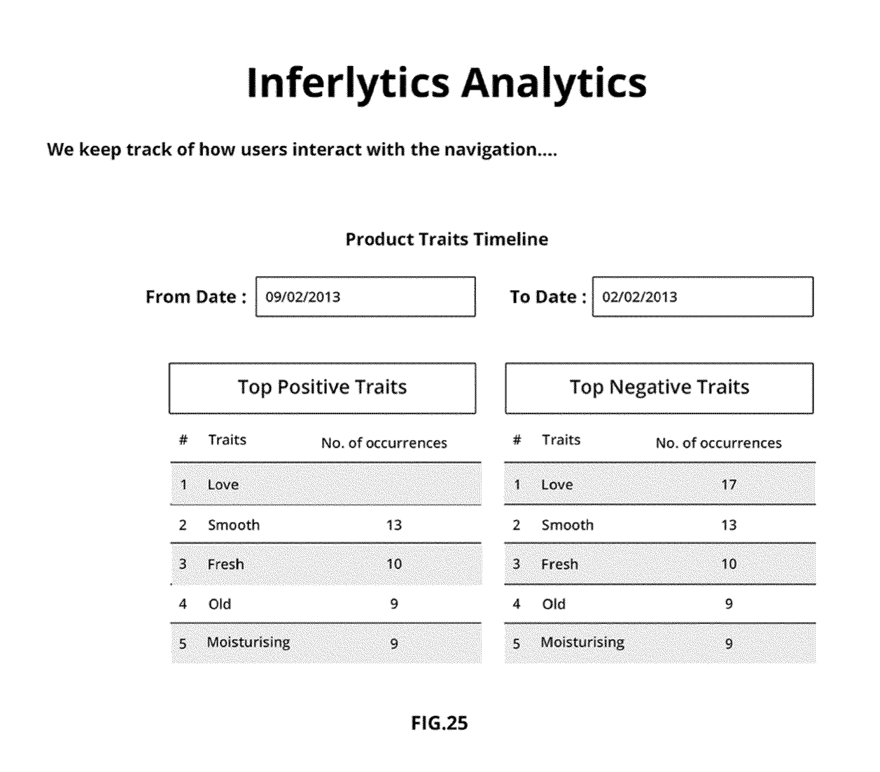

The analytics module can keep track of how users interact with the navigation. FIG. 25 shows an exemplary product traits timeline with the number of occurrences of navigation for positive traits, and the number of occurrences of the top negative traits in the online reviews. From this analysis, a merchant may be able to quickly see the top positive and negative traits that customers are talking about within a given time period about a particular product. This may also allow the merchant to track any changes in positive/negative traits over time, particularly if the merchant made a change to a product.

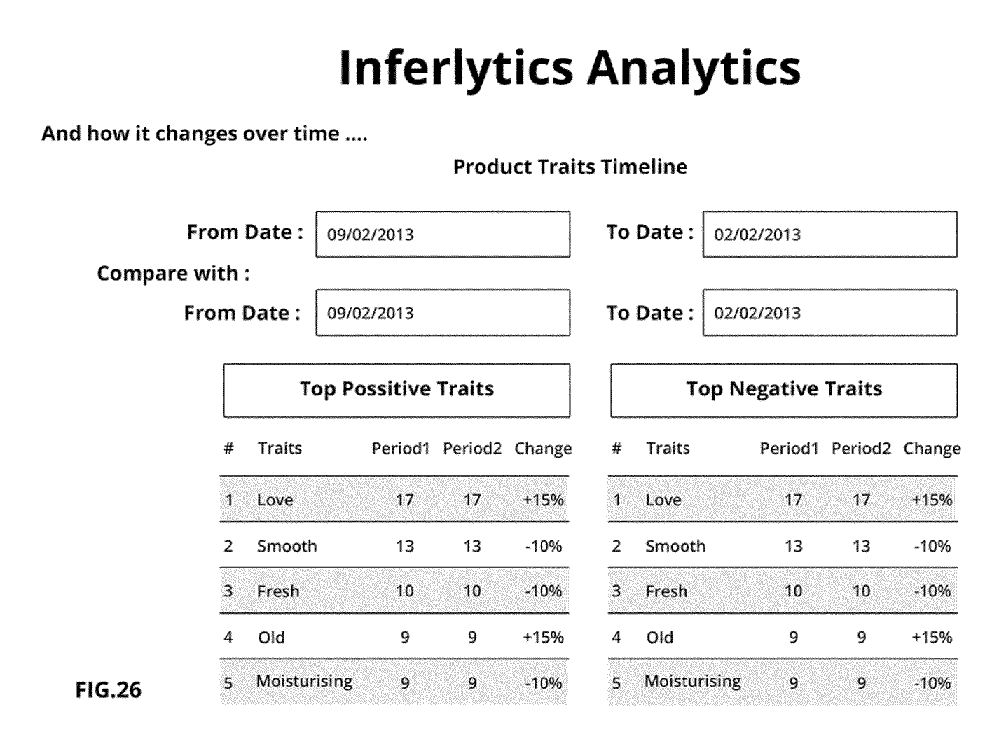

The analytics module is able to show how the user interaction with the navigation changes overtime. FIG. 26 shows a change of number of occurrences of navigation for positive traits and negative traits for a specific period.

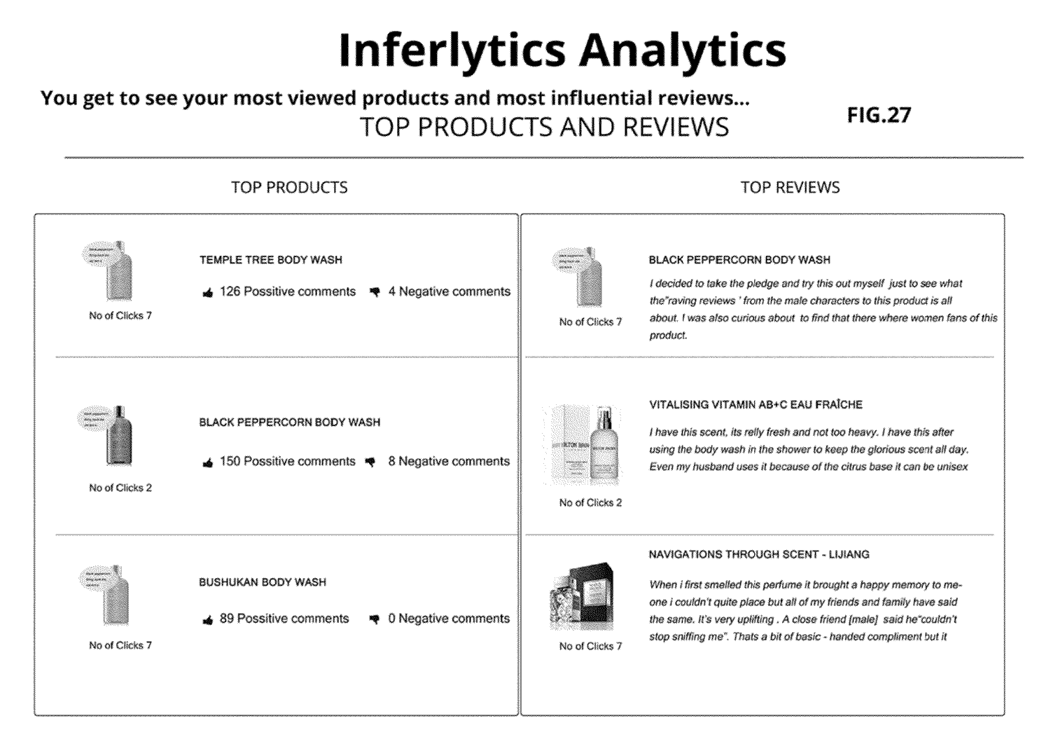

In example embodiments, the most viewed products and the most influential reviews may be provided to the customer or merchant. The number of positive and negative comments may be shown on the product in a summary table, for example, as shown in FIG. 27. The time period for which the analytics are shown may be customized, as well as the number of items shown on the display.

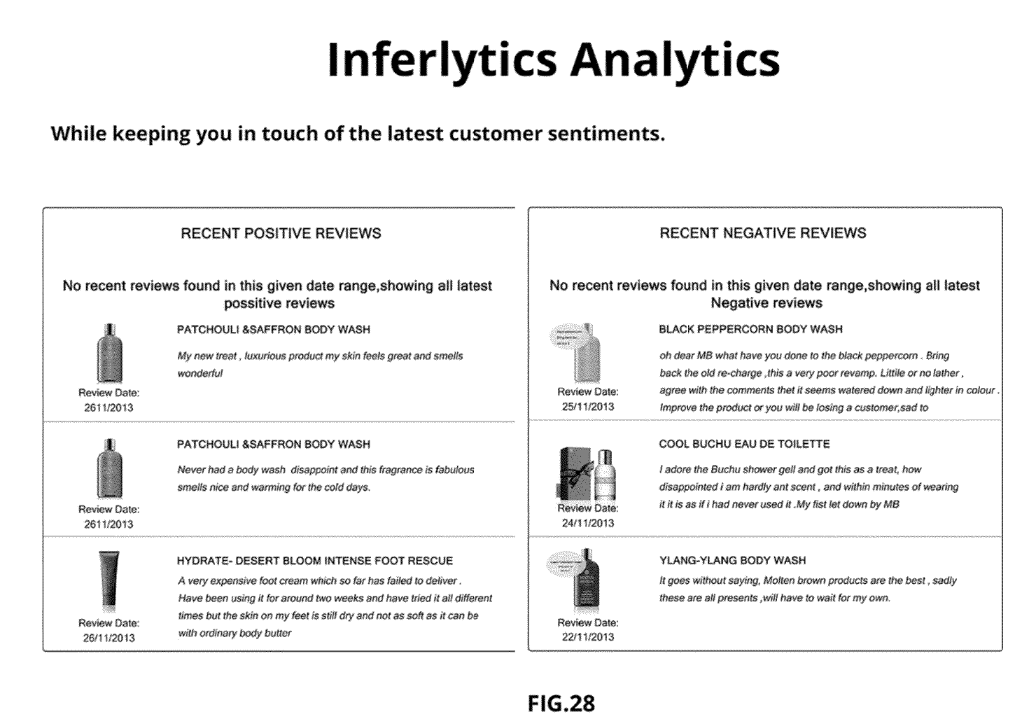

The system may also provide a display of the latest customer sentiments, provide the most recent positive reviews and the most recent negative reviews, as illustrated in FIG. 28. Optionally, the system can show all positive reviews and negative reviews added to the site after the last visit of the customer to the site. Furthermore, the system may send an e-mail notification to the customer when new reviews are added to a specific product in which the customer is interested.

In a further example embodiment, the text mining engine is used to pull reviews from a review site, such as the Yelp website, for specific locations of a retailer and create a dashboard for a manager of the retailer to see comments the users leave with respect to the particular store, how it relates to its competition, overall shopping experience, any comments about specific departments of the retailer, and so forth. Furthermore, the dashboard can show any specific employees mentioned, e.g. as being particularly helpful (positive) or not helpful (negative), and the like. This data can help managers to see where they succeed and where they need improvement to help with customer satisfaction and retention.

Thus, methods and systems for providing review based navigation on an e-commerce website have been described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

### Computing System

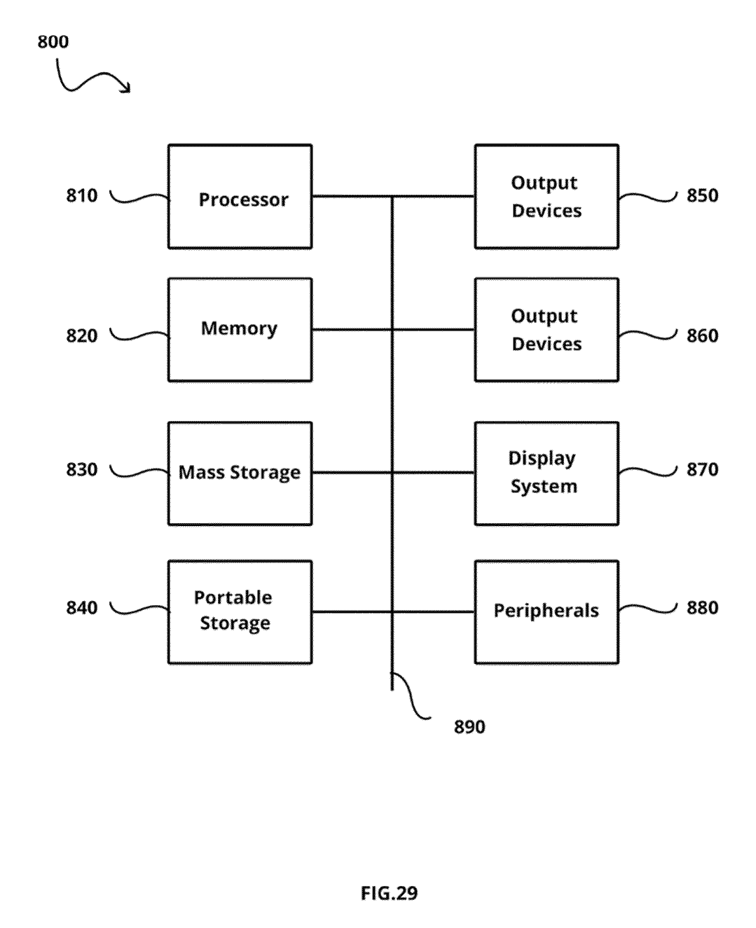

FIG. 29 illustrates an exemplary computing system 800 that may be used to implement an embodiment of the present systems and methods. The computing system 800 of FIG. 29 may be implemented in the contexts of the likes of computing devices, networks, webservers, databases, or combinations thereof. The computing device 800 of FIG. 29 includes a processor 810 and memory 820. Memory 820 stores, in part, instructions and data for execution by processor 810. Memory 820 may store the executable code when in operation. The computing system 800 of FIG. 29 further includes a mass storage device 830, portable storage device 840, output devices 850, input devices 860, a graphics display 870, and peripheral devices 880. The components shown in FIG. 29 are depicted as being connected via a single bus 890. The components may be connected through one or more data transport means. Processor 310 and memory 820 may be connected via a local microprocessor bus, and the mass storage device 830, peripheral device(s) 880, portable storage device 840, and graphics display 870 may be connected via one or more input/output (I/O) buses.

Mass storage device 830, which may be implemented with a magnetic disk drive or an optical disk drive, is a non-volatile storage device for storing data and instructions for use by processor 810. Mass storage device 830 can store the system software for implementing embodiments of the present technology for purposes of loading that software into memory 820.

Portable storage device 840 operates in conjunction with a portable non-volatile storage medium, such as a floppy disk, compact disk or digital video disc, to input and output data and code to and from the computing system 800 of FIG. 29. The system software for implementing embodiments of the present technology may be stored on such a portable medium and input to the computing system 800 via the portable storage device 840.

Input devices 880 provide a portion of a user interface. Input devices 860 may include an alphanumeric keypad, such as a keyboard, for inputting alphanumeric and other information, or a pointing device, such as a mouse, a trackball, stylus, or cursor direction keys. Additionally, the system 800 as shown in FIG. 29 includes output devices 850. Suitable output devices include speakers, printers, network interfaces, and monitors.

Graphics display 870 may include a liquid crystal display (LCD) or other suitable display device. Graphics display 870 receives textual and graphical information, and processes the information for output to the display device.

Peripherals 880 may include any type of computer support device to add additional functionality to the computing system. Peripheral device(s) 880 may include a modem or a router.

The components contained in the computing system 800 of FIG. 29 are those typically found in computing systems that may be suitable for use with embodiments of the present technology and are intended to represent a broad category of such computer components that are well known in the art. Thus, the computing system 300 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, LINUX, WINDOWS, MACINTOSH OS, IOS, ANDROID, CHROME, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computing system 800 may be implemented as a cloud-based computing environment, such as a virtual machine operating within a computing cloud. In other embodiments, the computing system 800 may itself include a cloud-based computing environment, where the functionalities of the computing system 800 are executed in a distributed fashion. Thus, the computing system 800, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computing device 200, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH memory, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as JAVA, SMALLTALK, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also he stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

1. A method for providing review based navigation on an e-commerce website, the method comprising: receiving, from a user, a query concerning a specific feature associated with a product; performing a sentiment analysis of a plurality of reviews associated with the product, wherein the sentiment analysis includes contextualization of the product based on the specific feature present in the plurality of reviews associated with the product; and facilitating navigation of the e-commerce website based on the sentiment analysis, the facilitating including displaying, in response to the query, a contextualized product, wherein the displaying the contextualized product includes displaying the strengths and weaknesses of the specific feature associated with the product and one or more portions of the plurality of reviews, the one or more portions being relevant to the specific feature.

2. The method of claim 1, further comprising:
extracting traits and features from the plurality of reviews associated with the product; and tagging the traits and features to a product within a product database to further enrich consumer search, marketing messaging, Search Engine Optimization (SEO), Search Engine Marketing (SEM) and other activities which rely on how consumers view the product.
